(19) United States
(12) Patent Application Publication
(10) Pub. No.: US 2016/0073450 A1
(43) Pub. Date: Mar. 10, 2016

(54) Transferring Information for Selection of Radio Access Technology

(71) Applicant: TELEFONAKTIEBOLAGET L M ERICSSON (PUBL), Stockholm (SE)

(72) Inventors: Jari Vikberg, Järna (SE); Tomas Hedberg, Stockholm (SE)

(21) Appl. No.: 14/786,182

(22) PCT Filed: Apr. 23, 2014
(86) PCT No.: PCT/SE2014/050482

§ 371 Date: Oct. 22, 2015

Related U.S. Application Data
(60) Provisional application No. 61/815,338, filed on Apr. 24, 2013.

(51) Int. Cl. H04W 88/06

(52) U.S. Cl. CPC H04W 88/06; H04W 84/12

(57) ABSTRACT

Bearer-based and mobile terminal-based mobility indicators are disclosed. These enable the core network to indicate radio-bearer-level or terminal-level mobility preferences for a mobile terminal to the RAN, enabling the RAN to take bearer-level or terminal-level mobility decisions. An example method is carried out in a core network node of a wireless communication system that includes a first radio access network, RAN, supporting a first radio access technology, RAT, and a second RAN supporting a second RAT. The example method includes signaling (720), to a node in the first RAN, a mobility indicator that indicates whether mobility with respect to a second RAT is allowed or disallowed for a particular radio bearer or for the entire context of a mobile terminal, or whether there is a preference for or against mobility to the second RAT. In some embodiments, the first RAT is a 3GPP RAT and the second RAT is Wi-Fi.

### TECHNICAL FIELD

The present disclosure is generally related to wireless communications systems, and is more particularly related to techniques for controlling the operation of mobile terminals with respect to the use of multiple radio access technologies.

### BACKGROUND

In legacy networks operating according to specifications developed by the 3^{rd}-Generation Partnership Project (3GPP), the focus of system designers generally has been on network-centric control of the mobile terminals (user equipment, or UEs, in 3GPP terminology) and of the network's usage of spectrum and network resources. There are several arguments that support this focus on network-centric control, including, for example:
The network has more information and thus a better ability to jointly optimize the network and end user performance, leading to user satisfaction at a lower cost.
System performance becomes more predictable with network-centric control, because the system's behavior does not depend on the effectiveness of the UE implementation, which may vary from one manufacturer or model to another.

However, techniques for controlling the operation of mobile terminals and their usage of spectrum and network resources is complicated by the recent emergence of mobile terminals that support multiple radio-access technologies (RATs). One example is the emergence of mobile terminals that support one or more wide-area 3GPP network standards, such as LTE, as well as one or more of the IEEE 802.11 wireless local-area network (WLAN) standards. While the latter RATs may be referred to as “Wi-Fi” networks in the discussion that follows, it should be understood that the techniques described herein may be applied in the context of other wireless local-area network standards as well.

In the context of a 3GPP network, such as those supporting any one or more of the well-known Long-Term Evolution (LTE), Wideband Code-Division Multiple Access (WCDMA), High-Speed Packet Access (HSPA) or Global Mobile System (GSM) radio access technologies (RATs), the information needed to carry out an efficient selection among RATs for any given mobile terminal is large, and is stored partly in the 3GPP Core Network (CN) and partly in the 3GPP Radio Access Network (RAN). FIG. 1 illustrates an example allocation of information needed for RAT selection among components of the CN and RAN. As seen in FIG. 1, information about UE capabilities and the environment seen by the UE, as reflected in measurements taken by the UE, is known to the RAN; UE capabilities information is also known to the CN. The RAN also has information about the RAN topology, network capabilities, and current network performance, e.g., as indicated by network loading measurements and radio link quality measurements. In addition to UE capabilities information, the CN also has information about allowed Public Land Mobile Networks (PLMNs) and allowed Radio Access Technologies (RATs) for particular mobile terminals. This information may be maintained by or in association with a Policy Control and Charging (PCC) function residing in the CN; the PCC function may comprise, for example, a Home Subscriber Server (HSS), a charging functionality, and/or a service detection functionality, which together are part of a Service Network functionality.

Much of the CN information is currently passed on to the RAN, for example when a UE becomes “RRC Connected” and/or when radio bearers for the mobile terminal are added or modified. Examples of the CN information include: cooperating/allowed PLMNs; subscription information, such as allowed RATs, quality-of-service (QoS) rules, etc. This information is passed over A/Gb, lu and S1 interfaces. The RAN also has its own information about, for example: available cells and radio technologies; the quality of existing and potential radio links; cell loads, including the mix of UEs with different QoS requirements present in different cells; etc. When selecting a RAT for a given UE to use, the RAN makes a composite decision, taking both Core Network and Radio Access Network information into account.

In contrast to the generally network-centric approach in legacy 3GPP networks, the techniques currently proposed for supporting the integration of WLAN and 3GPP networks (WLAN-3GPP integration) are UE-centric. According to these techniques, the UE is provided with (mainly) Core Network information using Access Network Discovery and Selection Function (ANDSF) techniques defined by 3GPP. The content of the information provided to the UEs largely corresponds to the information that is passed over A/Gb, lu and S1 interfaces, as discussed above. Note that the existing interfaces between the Core Network and the 3GPP RAN have no WLAN-related or Wi-Fi-related information at all.

ANDSF was first defined in Release 8 of the 3GPP standards, and continues to evolve. FIG. 2 is a system diagram illustrating principles of the ANDSF techniques, and shows that the communication between the UE and the ANDSF server is defined as an IP-based S14-interface. The IP-based S14 interface may partly be based on the use of a gateway (GW), which links a Wi-Fi or other WLAN or one or more wide-area RAT(s) to an ANDSF server. ANDSF provides the possibility to send different policies to the UE for access network discovery and selection. The communication between the UE and the ANDSF server is defined as an IP-based S14-interface.

Several types of information are used to carry out ANDSF functionality. These include:
Access Discovery Information (ANDI), which is used to provide access discovery information to the UE. This information can assist the UE to discover available (3GPP and) non-3GPP access networks without the burden of continuous background scanning.
Inter-System Mobility Policies (ISMP), which are policies that guide the UE to select the most preferable 3GPP or non-3GPP access. The ISMP are used for UEs that access a single access (3GPP or Wi-Fi) at a time.
Inter-System Routing Policies (ISRP), which are policies that guide the UE to select over which access a certain type of traffic or a certain APN shall be routed.

The ISRP are used for UEs that can access both 3GPP and Wi-Fi simultaneously. The above ANDI, ISMP and ISRP have been extended with additional policies in the later 3GPP releases, for example WLAN selection policy (WLANSP) and Inter-APN Routing Policies (IARP) policies.

ANDSF servers may exist in each operator's network (PLMN). A roaming UE may thus receive policies from its Home PLMN and from its current visited network (VPLMN). This is shown in FIG. 3, which shows the roaming architecture for ANDSF and which is based on FIG. 4.8.1.1-2 in the 3GPP document “Architecture Enhancements for non-3GPP Accesses, 3GPP TS 23.402, v. 12.0.0 (Mar. 2013).

FIG. 4 illustrates a possible integrated mobile network architecture for the case of Long-Term Evolution/Evolved Packet Core (LTE/EPC) and Wi-Fi. Seen in FIG. 4 is a UE 410, a E-UTRAN 420 (which typically comprises several evolved Node Bs or eNBs), and several Core Network nodes that make up the so-called Evolved Packet Core (EPC), including the Mobility Management Entity 430, Serving Gateway (S-GW) 440, Packet Data Network Gateway (P-GW) 450, Policy and Charging Rules Function (PCRF) 460, and Home Subscriber Server (HSS) 470. FIG. 4 also shows several core network nodes related to W-LAN integration, including 3GPP Authentication, Authorization, and Accounting (AAA) server 475, ANDSF server 480, and Trusted Wireless Access Gateway (TWAG) 485. Further information regarding these nodes can be found in the 3GPP document referenced above, i.e., 3GPP TS 23.402, v. 12.0.0. It will be appreciated that any of these various nodes may be logical nodes, rather than physical nodes, and thus may be mapped to physical devices in any number of ways, e.g., where two or more of the illustrated nodes reside on a single device or where one of the nodes is split between two physical devices.

While 3GPP has made progress in defining a mobile network architecture that combines W-LAN access with one or more 3GPP RATs, work in defining mobile terminal operation in these networks is needed.

### SUMMARY

As noted above, there are several advantages to network-based control of mobile terminal operation. Thus, RAN-based control of the UE's use of 3GPP RAT versus Wi-Fi is of considerable interest to wireless network operators. To provide such RAN-based control, however, RAN nodes must be provided with Core Network information related to WLAN. Doing so would mean that ANDSF ISRP-policies are not needed on the UE side, for example.

To that end, disclosed herein are new apparatus and techniques that utilize a “Bearer-based mobility preference Indicator (BBMPI) including Wi-Fi.” These new techniques and apparatus enable the core network to indicate radio-bearer-level mobility preferences for a mobile terminal to the RAN, so that the RAN can take bearer-level mobility decisions based on any existing or new information and mechanisms in the core and service network levels. As detailed below, the BBMPI approach described herein can be extended to cover a closely related “UE-based mobility preference indicator (UBMPI) including Wi-Fi”. The detailed discussion that follows also describes the principles of how the BBMPI (or UBMPI) can be transported either over existing or new interfaces between the RAN and the CN.

An example method according to the presently disclosed techniques is carried out in a core network node of a wireless communication system, the wireless communication system comprising a core network and a first radio access network (RAN) supporting a first radio access technology (RAT) and a second RAN supporting a second RAT. The example method includes signaling, to a node in the first RAN, a mobility indicator that indicates whether mobility with respect to a second RAT is allowed or disallowed for at least one radio bearer, or whether there is a preference for or against mobility of the radio bearer to the second RAT. In some embodiments, the first RAT is a 3GPP RAT and the second RAT is Wi-Fi, but in other embodiments or in other instances, the first and second RAT may be differing 3GPP RATs.

In some embodiments, the method summarized above further comprises detecting a trigger event, where the signaling discussed above is performed in response to detecting the trigger event. This trigger event may comprise one of the following, for example: an addition of a radio bearer; a modification of an existing radio bearer; detection of a handover event or an impending handover event; receiving of new subscription-related information for a mobile terminal; detection of a specific application or service for a mobile terminal; and a change in dynamic Quality-of-Service (QoS) control resulting in a radio bearer modification.

A variant of the example methods described above is also carried out in a core network node of a wireless communication system that comprises a core network and a first RAN supporting a first RAT and a second RAN supporting a second RAT. This variant also includes signaling, to a node in the first RAN, a mobility indicator. In this case, however the mobility indicator applies to a mobile terminal (i.e., to all radio bearers associated with a mobile terminal), rather than to a particular radio bearer. Thus, the mobility indicator indicates whether mobility with respect to a second RAT is allowed or disallowed for a particular mobile terminal, or whether there is a preference for or against mobility of the mobility to the second RAT. All of the variants of the first method summarized above are equally variable to this method.

Methods carried out in a radio access network (RAN) node are also detailed below. One such method includes receiving mobility signaling from a core network node, the mobility signaling comprising a mobility indicator that indicates an allowed, disallowed, or preferred mobility of at least one radio bearer from the first RAN to a second RAN with a second RAT, different from the first RAT. In some embodiments, the method further comprises deciding whether or not to transfer a radio bearer connection from the first RAN to the second RAN, based on the received mobility indicator of the radio bearer. Thus, in some cases the RAN node may decide to transfer a radio bearer connection to the second RAN, based on the received mobility indicator, such as when the mobility indicator indicates that such mobility is allowed or preferred, while in other cases the RAN node may decide not to transfer the radio bearer connection, based on the received mobility indicator.

Apparatus corresponding to the above-summarized methods are also detailed in the following detailed description. These apparatus include, for example, a core network node in a core network of a wireless communication system. The core network node includes a network interface circuit adapted for communication with one or more nodes in a first RAN, using a first RAT, and a processing circuit adapted to signal, to a network node in the first RAN, a mobility indicator that indicates an allowed, disallowed, or preferred mobility of at least one radio bearer from the first RAN with the first RAT to a second RAN with a second RAT. Similarly, the disclosed apparatus also include a network node in a first RAN, supporting a first RAT, and comprising a network interface circuit adapted for communication with one or more nodes in a core network of a wireless communication system and a processing circuit adapted to receive mobility signaling from a core network node, the mobility signaling comprising a mobility indicator that indicates an allowed, disallowed, or preferred mobility of at least one radio bearer from the first RAN to a second RAN with a second RAT, different from the first RAT. Variants of these apparatus are adapted to handle mobility indicators that indicate an allowed, disallowed, or preferred mobile of a mobile terminal, rather than a particular radio bearer.

Other example methods and apparatus according to the presently disclosed techniques for handling mobility between different RATs are described in detail below.

### BRIEF DESCRIPTION OF THE DRAWINGS

FIG. 1 illustrates an allocation of information needed for Radio Access Technology (RAT) selection among components of the core network (CN) and Radio Access Network (RAN).

FIG. 2 is a system diagram illustrating principles of the Access Network Discovery and Selection Function (ANDSF) techniques defined by 3GPP.

FIG. 3 illustrates aspect of the roaming architecture for ANDSF.

FIG. 4 shows an integrated mobile network architecture for LTE/EPC and Wi-Fi.

FIG. 5 is a signaling flow diagram illustrating an example of an LTE/EPC attach procedure that uses a bearer-based mobility preference Indicator (BBMPI).

FIG. 6 is a signaling flow diagram illustrating an example of a network-initiated bearer modification procedure that uses a bearer-based mobility preference Indicator (BBMPI).

FIG. 7 is a process flow diagram illustrating an example method for carrying out a radio bearer transfer based on a signaled mobility indicator.

FIG. 8 is a process flow diagram illustrating another example method for carrying out a radio bearer transfer based on a signaled mobility indicator.

FIG. 9 is a block diagram illustrating an example core network node adapted to carry out one or more of the techniques detailed herein.

FIG. 10 is a block diagram illustrating an example RAN node adapted to carry out one or more of the techniques detailed herein.

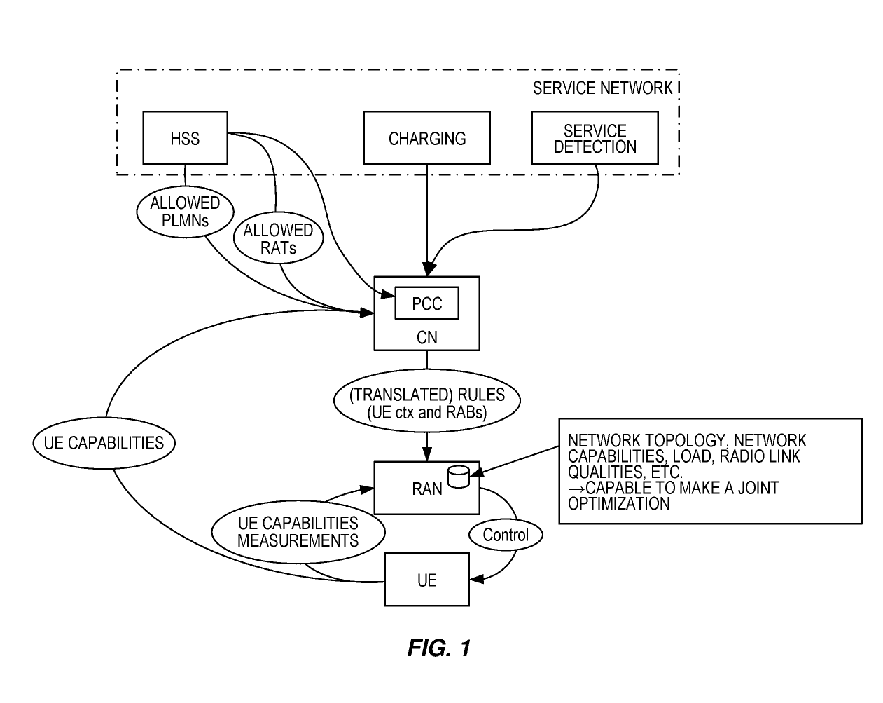

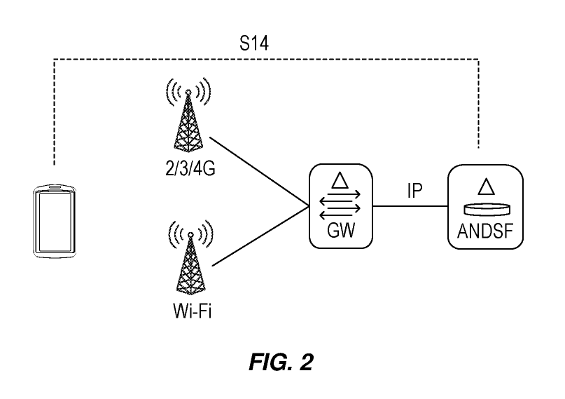

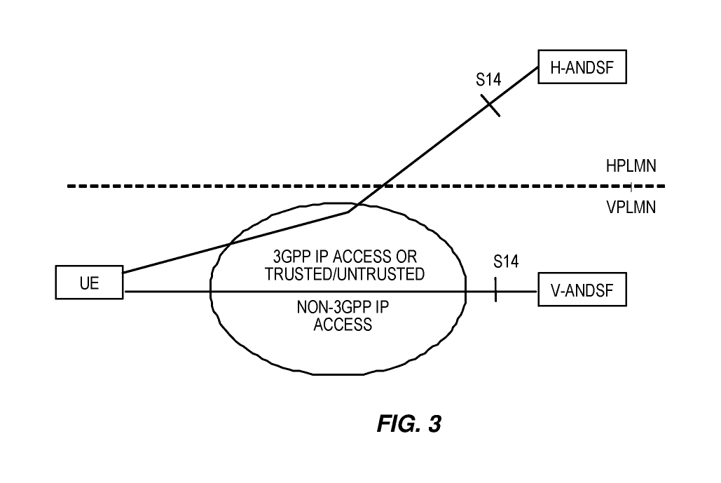

### DETAILED DESCRIPTION

The discussion below describes several techniques for addressing mobility in scenarios where a wireless communication system that includes a core network and at least two RANs, each of the RANs supporting a different RAT. The techniques and apparatus described below are particularly applicable to scenarios where the different RATs include a 3GPP RAT (such as LTE, W-CDMA, HSPA, or GSM) and a WLAN technology, such as the family of technologies commonly referred to as Wi-Fi. For that reason, the discussion below is primarily focused on a detailed application of the techniques to that scenario. However, it will be appreciated that the techniques may be applied more generally, e.g., to scenarios where both of the RATs are 3GPP RATs or where neither is a 3GPP RAT. Other wireless communications networks, including those that include other wide-area RATs as well as other WLAN techniques, may benefit from applications of the techniques described and apparatus described below.

It will also be understood that the term “mobile terminal,” as used herein, should be understood to refer generally to wireless devices that enable a user or an application (such as a machine-based application) to access a radio network, via one or several access points, which may be referred to as base stations, wireless access points, Node Bs, etc. A “mobile terminal,” then, need not necessarily be mobile, such as when the wireless device is used in a fixed-point application (such as for wireless telemetry, for example), but includes such devices as cellular telephones, smartphones, wireless-equipped tablets, and the like. In 3GPP terminology, a mobile terminal is generally referred to as “user equipment,” or “UE,” while wireless local area network (WLAN) standards may refer to a mobile terminal as a wireless station, or “STA.” For the purposes of the present disclosure, these terms may be understood to be interchangeable. It will also be understood that while a mobile terminal generally supports at least one radio access technology (RAT), e.g., a 3GPP RAT, the mobile terminals discussed below may support multiple RATs, such as a 3GPP RAT and a WLAN technology.

To provide RAN-based control of mobility between two RATs, e.g., from a RAN supporting a 3GPP RAT to a WLAN RAN, RAN nodes must be provided with Core Network information related to WLAN. This would mean that ANDSF ISRP-policies are not needed on the mobile terminal (UE) side, for example. To that end, detailed below are new mechanisms called “Bearer-based mobility preference Indicator (BBMPI) including Wi-Fi,” which enable the core network to indicate radio bearer-level mobility preferences to the RAN so that the RAN can take bearer level mobility decisions based on any existing or new information and mechanisms in the core and service network levels. As detailed below, the BBMPI approach described herein can be extended to cover the case of “UE-based mobility preference indicator (UBMPI) including Wi-Fi”. The detailed discussion that follows also describes the principles of how the BBMPI (or UBMPI) can be transported either over existing or new interfaces between the RAN and the CN.

### Bearer-Based Mobility Preference

One principle underlying the presently disclosed techniques is the defining of a new mechanism called “Bearer-based mobility preference Indicator including Wi-Fi” (BBMPI), which enables the core network to indicate mobility preferences to the RAN on a radio bearer level, so that that RAN can take bearer-level mobility decisions based on any existing or new information and mechanisms in the core and service network levels.

In some embodiments, this bearer-based mobility preference Indicator (BBMPI) is sent to the RAN from the CN at any signaling that creates or modifies radio bearers. The BBMPI could for example indicate any of the following:
“Wi-Fi not allowed for this bearer”
“Wi-Fi allowed for this bearer”
“Wi-Fi preferred for this bearer”

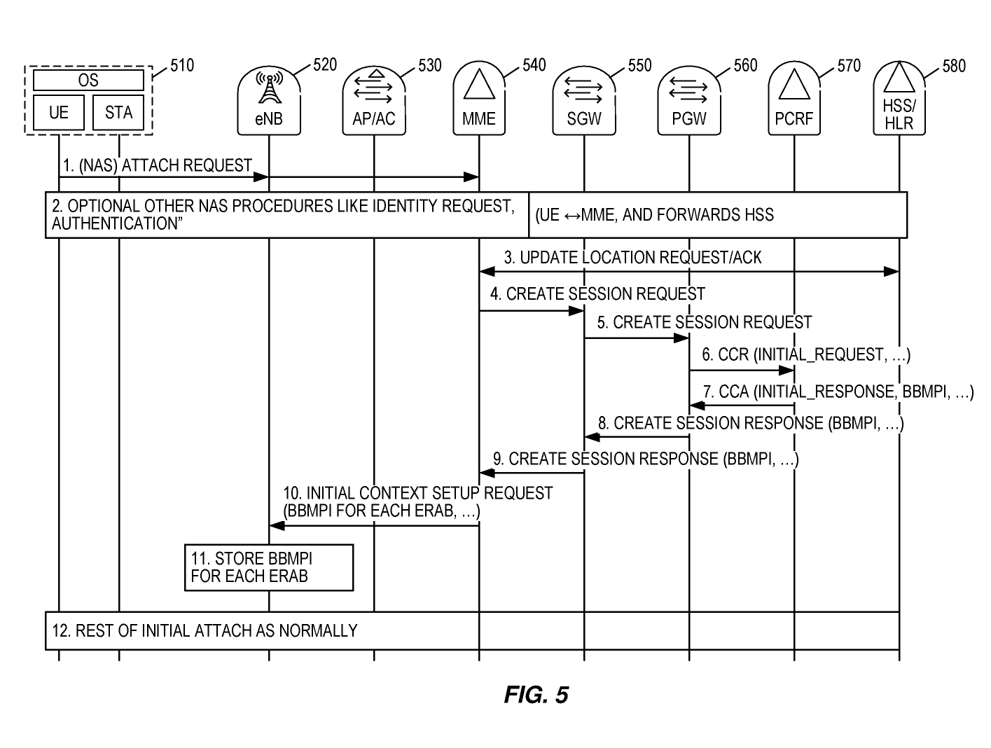

One example of such a case is given in FIG. 5, which provides a simplified view of the LTE/EPC attach procedure, as modified to account for the introduction of the BBMPI. Note that the same principles can also be applied to other 3GPP radio access technologies/networks, such as UTRAN and GERAN, and to even other radio accesses, such as the ones defined as part of 3GPP2.

As seen in FIG. 5, the attach procedure begins with a mobile terminal 510, which in this case is adapted for operation in both the LTE network and a WLAN, sending a Non-Access Stratum (NAS) “Attach Request” to the MME 540, via the eNB 520, as shown at step 1. Other NAS procedures, e.g., for verifying identity, authenticating the mobile terminal, etc., may be carried out as shown at step 2—these operations may be carried out between the UE 510 and the MME 540, for example, as well as between the MME 540 and the Home Subscriber Server (HSS)/Home Location Register (HLR) 580.

As shown at step 3, the MME 540 subsequently sends an “Update Location Request” to the HSS/HLR 580, which responds with an acknowledgement. As seen at step 4, the MME 540 sends a “Create Session Request” to the SGW 550, which forwards it to the PGW 560. The PGW then sends a “CCR (Initial Request, . . . )” message to the PCRF 570.

Up to this point, the illustrated attach procedure follows the conventional procedure. Subsequently, however, beginning at step 7, the BBMPI (mobility indicator) is introduced. Thus, the PCRF 570 responds to the PGW 560 with a “CCA (Initial_Response, BBMPI, . . . )” message —notably, this message includes a BBMPI for each bearer included in the message. The BBMPI is a mobility indicator that indicates whether mobility with respect to WLAN is allowed or disallowed for a radio bearer associated with mobile terminal 510, or whether there is a preference for or against mobility of the radio bearer to WLAN. The BBMPI(s) is(are) forwarded to the SGW 550 and then to the MME 540, as shown at steps 8 and 9; the MME 540 then sends an “Initial Context Setup Request” to the eNB 520 serving the mobile terminal 510, with the “Initial Context Setup Request” including a BBMPI for each Evolved Packet Subsystem Radio Access Bearer (E-RAB) for the mobile terminal 510. As shown at step 11, the BBMPI for each E-RAB is stored by the eNB, for use in making subsequent mobility decisions for mobile terminal 510. The rest of the initial attach procedure continues normally, as shown at step 12.

It should be understood that the procedure shown in FIG. 5 is but one example of how a radio bearer-based mobility preference indicator may be introduced into network procedures. It will be appreciated that a similar approach may be taken with respect to a terminal-based mobility preference indicator, which indicates whether mobility to a second RAT (e.g., a WLAN) is allowed, disallowed, or preferred for all radio bearers associated with a particular mobile terminal. Such a terminal-level mobility preference indicator is referred to herein as a UE-based mobility preference indicator (UBMPI), but, of course, other names may be used for similar indicators.

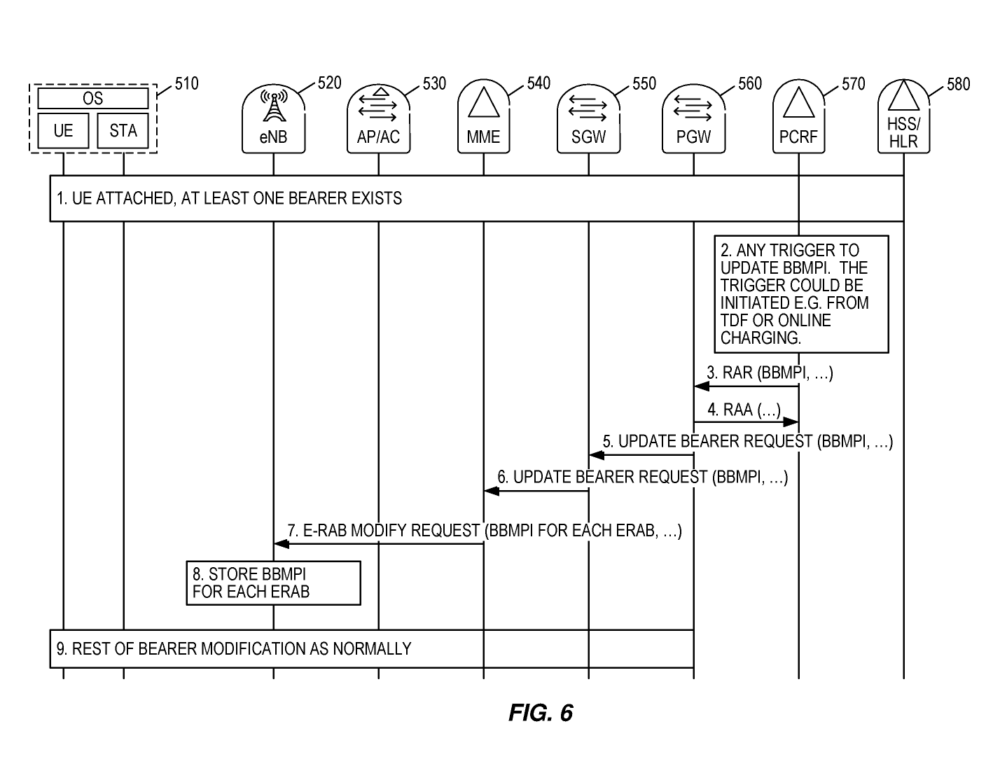

Another example of how mobility preference indicators may be incorporated into network procedures is given in FIG. 6, which is a signaling flow illustrating an example Network initiated LTE/EPC Bearer modification procedure (simplified), as modified by introduction of the BBMPI.

This example signaling flow begins, as shown at step 1, with the mobile terminal 510 attached to the LTE RAN. Thus, its presence is known to the MME 540, SGW 550, PGW 560, Policy and Charging Rules Function (PCRF) 570, and HSS/HLR 580. As shown at step 2, an event occurs, triggering an update of the BBMPI for a particular radio bearer of mobile terminal 510 (or for all radio bearers of mobile terminal 510)—this triggering may result, for example, from a Traffic Detection Function (TDF) event, or by a change with respect to online charging.

As shown at step 3, the PCRF 570 sends a Re-authorization Request” (RAR) message to the PGW 560, which responds with a “Re-authorization Answer” (RAA) message as shown at step 4. The RAR message includes a BBMPI for each bearer included in the message. The BBMPI is a mobility indicator that indicates whether mobility with respect to WLAN is allowed or disallowed for a particular radio bearer associated with mobile terminal 510, or whether there is a preference for or against mobility of the radio bearer to WLAN. The BBMPI(s) is(are) forwarded to the SGW 550 and from there to the MME 540, as shown at steps 5 and 6, in an “Update Bearer Request” message that includes the BBMIP. The MME 540 then sends an “E-RAB Modify Request” to the eNB 520, as shown at step 7, the E-RAB Modify Request including a BBMPI for each affected E-RAB (or, in some embodiments, a UBMPI that applies to all bearers for the mobile terminal 510). As shown at step 8, the BBMPI for each E-RAB is stored, for use in subsequent decisions regarding the mobility of mobile terminal 510. The rest of the bearer modification process is carried out normally, as shown at step 9.

The example signaling flows shown in FIGS. 5 and 6 indicate how the different protocols in the different interfaces could be impacted. Here, a short exemplary description is given to further describe some of the different possibilities for transferring the BBMPI information:
1. Over the Gx-interface in DIAMETER messages between the PCRF and the PGW. These DIAMETER messages are currently defined in “Policy and Charging Control (PCC); Reference Points,” 3GPP TS 29.212, v. 12.0.0 (Mar. 2013), and could be modified to incorporate a BBMPI as described above. Alternatively messages in another protocol, like RADIUS, might be modified, if used over this interface.
   More particularly, the BBMPI may be added to the CCA (Credit-Control-Answer) and Re-Auth-Request (RAR) messages, either as a new information element (IE) or as a part of any existing bearer-level IE, for example.
2. Over the S5 interface (between PGW and SGW) and S11 interface (between SGW and MME) in the GTP-C protocol, as currently defined, for example, in “3GPP Evolved Packet System (EPS); Evolved General Packet Radio Service (GPRS) Tunnelling Protocol for Control Plane (GTPv2-C); Stage 3,” 3GPP TS 29.274, v. 12.0.0 (Mar. 2013).
   More particularly, the BBMPI may be added to the Create Session Request and Update Bearer Request messages either as a new IE or as a part of any existing bearer-level IE, for example.
3. Over the S1-MME interface (between MME and eNB) in the S1AP protocol, as currently defined, for example, in “Evolved Universal Terrestrial Radio Access Network (E-UTRAN); S1 Application Protocol (S1AP),” 3GPP TS 36.413, v. 11.3.0 (Mar. 2013).
More particularly, the BBMPI may be added to the Initial Context Setup Request and E-RAB Modify Request messages, either as a new IE or as a part of any existing bearer-level IE. The BBMPI could also be added, for example, in the E-RAB SETUP REQUEST message.

The examples shown in FIGS. 5 and 6 are to be seen as examples of how the Mobility Management Entity (MME) receives the trigger to perform the signaling towards the RAN. Other triggers and information sources than the ones shown are also possible. For example, information could be received in the MME from HLR/HSS. Triggers could be based on any of several different inputs, such as time-of-day. Examples of other possible triggers include:
Detection of a handover event or impending handover.
Receiving of new subscription related information (e.g., in the MME, from the HSS)
Detection of specific applications and services, for example, in the Traffic Detection Function (TDF) and then communicated, for example, to the PCRF. This would then also likely result in a modification or addition of radio bearers.
Any other dynamic quality-of-service (QoS) Control resulting in radio bearer modification, such as a fair usage policy control (e.g., in the event of “End of bucket” conditions).
Any of the triggers received in the MME can also be used in combination with locally configured information in the MME to further decide on the exact contents of the communication towards the RAN.

In addition to the above examples, the BBMPI may also be forwarded between the different RAN nodes in the different radio access technologies (e.g., eNB, RNC, BSC or Wi-Fi AC/WIC), during handovers within and between the different RATs. One example is to append the BBMPI information to the source-to-target container passed transparently between RAN nodes as part of handover preparation phase signaling. These source-to-target containers differ, depending on the target RAT for the handover. Example details are as follows:
a. If the target RAT is LTE, BBMPI information may be included in the “Source eNB to Target eNB Transparent Container IE” defined in 3GPP TS 36.413 (as cited above). Note that the intra-LTE handover case could likely be supported also by using other information elements available in the X2 signaling.
b. If the target RAT is WCDMA/UTRAN, the BBMPI information may be included in the “Source RNC to Target RNC Transparent Container IE” defined in “UTRAN lu Interface Radio Access Network Application (RANAP) Signalling,” 3GPP TS 25.413, v. 11.3.0 (Mar. 2013).
c. If the target RAT is GSM/GERAN, BBMPI information may be included in the “Source BSS to Target BSS Transparent Container IE” as defined in “General Packet Radio Service (GPRS); Base Station System (BSS)—Serving GPRS Support Node (SGSN); BSS GPRS protocol (BSSGP),” 3GPP TS 48.018, v. 11.2.0 (Mar. 2013).
d. If the target is GSM/GERAN and a Single-Radio Voice Call Continuity (SRVCC) handover would be triggered, BBMPI information may be included in the “Old BSS to New BSS information IE” as defined in “Mobile Switching Centre—Base Station system (MSC-BSS) interface; Layer 3 specification,” 3GPP TS 48.008, v. 11.4.0 (Mar. 2013).

The forwarding of Core Network information at inter-RAT handover is done by the Core Network in the current 3GPP architecture. This also applies for intra-RAT handover cases that are signaled via the CN. Another possibility for the transparent containers described above is that the CN provides the information to the target radio access, either as part of handover preparation signaling or after this signaling.

### UE-Based Mobility Preference

The techniques for handling a BBMPI detailed below can also be modified to apply to the whole mobile terminal, i.e., such that the mobility indicator indicates whether mobility is allowed or disallowed for all radio bearers for a mobile terminal, or whether mobility to a second RAT is preferred for all radio bearers for the mobile terminal. A more correct term in this case would be UE-based mobility preference Indicator (UBMPI), of course. This means that the mobility indicator value would not need to be signaled from the CN to the RAN as part of bearer-level signaling. Instead it could be included in the signaling using information elements that apply for the entire UE context in the RAN. For example, in the LTE/E-UTRAN case the information sent from the CN to RAN would not need to be on E-RAB level and it would be sufficient to have information elements applying to the whole UE context. One such example would be to include the UE-context level “BBMPI” in the S1AP UE Context Modification Request message from the MME to the eNB.

### Extension to New Interfaces Between RAN and CN

The signaling of BBMPI (and/or UBMPI) to the RAN can also be performed over new interfaces between the RAN and the CN. Any node in or above the CN (as seen from RAN), such as the PCRF, ANDSF server, PGW or any so-called (S)Gi-interface box, could signal to the current serving RAN node for the UE using such a new interface. Generally, the area of enabling communication between service/core network nodes and RAN nodes is being worked on by 3GPP working groups in the Smart Mobile Broadband area, and the different solutions under development include the so-called inband, outband, and hybrid solutions. The main principle is that the node wishing to communicate with the RAN node is able to locate the current serving RAN node for the UE and then uses this knowledge to communicate with that RAN node. To support signaling of a BBMPI and/or UBMPI, signaling needs to be able to be identified towards a specific UE context in the RAN, and also towards specific radio bearers as needed.

### Extension to Small Cells Other Than Wi-Fi

The detailed description given above, including the discussion of FIGS. 5 and 6, focuses mainly for the case of adding Wi-Fi/WLAN related BBMPI (and UBMPI) to the bearer and UE context related signaling in a 3GPP network. The techniques described above, however, may also be applied in an intra-3GPP case, such as when a UE is capable of being connected to different 3GPP RATs at the same time. In this case, the techniques can also be extended to bearer-based cell layer indication, meaning that some bearers would not be allowed or would be preferred in 3GPP small cells. This could be indicated to the RAN by the CN in the same way as the above BBMPI, for example:
“Small cells not allowed for this bearer”
“Small cells allowed for this bearer”
“Small cells preferred for this bearer”
The indication could also be RAT-specific (e.g., “GSM small cells not allowed” but “LTE small cells allowed for this bearer”).

### Extension to Cells Belonging to Different Subnetworks

The techniques described above could further be applied to specifically identified networks, in some embodiments. Networks can be identified by e.g. PLMN ID, SSID or HESSID. These embodiments could be used to prevent some UEs from accessing non-cooperating networks, for example. These techniques could also be used to add more cooperating networks, in a similar way as EPLMNs are added for 3GPP cells when the UE enters an area with more cooperating networks.

### Method Embodiments

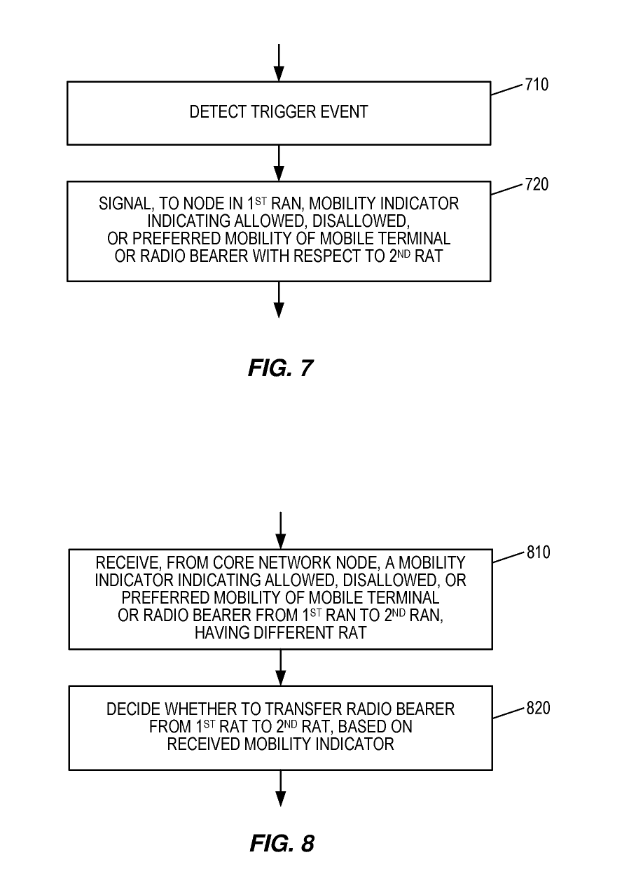

Given the above detailed examples for the handling of a BBMPI and/or UBMPI in a wireless network, it will be appreciated that the process flow diagrams of FIGS. 7 and 8 each illustrate an example of a generalized method, as performed in a core network node and in a radio access network (RAN) node, respectively.

More particularly, FIG. 7 illustrates an example method, according to the presently disclosed techniques, as carried out in a core network node of a wireless communication system that comprises a core network and a first radio access network (RAN) supporting a first radio access technology (RAT) and a second RAN supporting a second RAT. As shown at block 720, the illustrated method includes signaling, to a node in the first RAN, a mobility indicator that indicates whether mobility with respect to a second RAT is allowed or disallowed for a particular radio bearer or bearers, or for a particular mobile terminal, or whether there is a preference for or against mobility of the radio bearer or mobile terminal to the second RAT. In some embodiments, the first RAT is a 3GPP RAT and the second RAT is Wi-Fi, but in other embodiments or in other instances, the first and second RAT may be differing 3GPP RATs.

In some embodiments, the method further comprises detecting a trigger event, where the signaling discussed above is performed in response to detecting the trigger event. This is shown at block 710 in FIG. 7. The trigger event may comprise one of the following, for example: an addition of a radio bearer; a modification of an existing radio bearer; detection of a handover event or an impending handover event; receiving of new subscription-related information for a mobile terminal; detection of a specific application or service for a mobile terminal; and a change in dynamic Quality-of-Service (QoS) control resulting in a radio bearer modification.

FIG. 8 illustrates another example method, as carried out in a radio access network (RAN) node are also detailed below. As shown at block 810, the illustrated method includes receiving mobility signaling from a core network node, the mobility signaling comprising a mobility indicator that indicates an allowed, disallowed, or preferred mobility of at least one radio bearer or mobile terminal from the first RAN to a second RAN with a second RAT. As suggested by FIG. 8, this second RAT may be different from the first RAT, e.g., where the first RAT is a 3GPP RAT and the second RAT is Wi-Fi. As shown at block 820, the method further comprises deciding whether or not to transfer one or more radio bearer connections, or all radio bearer connections for the mobile terminal, from the first RAN to the second RAN, based on the received mobility indicator of the radio bearer.

### Apparatus Embodiments

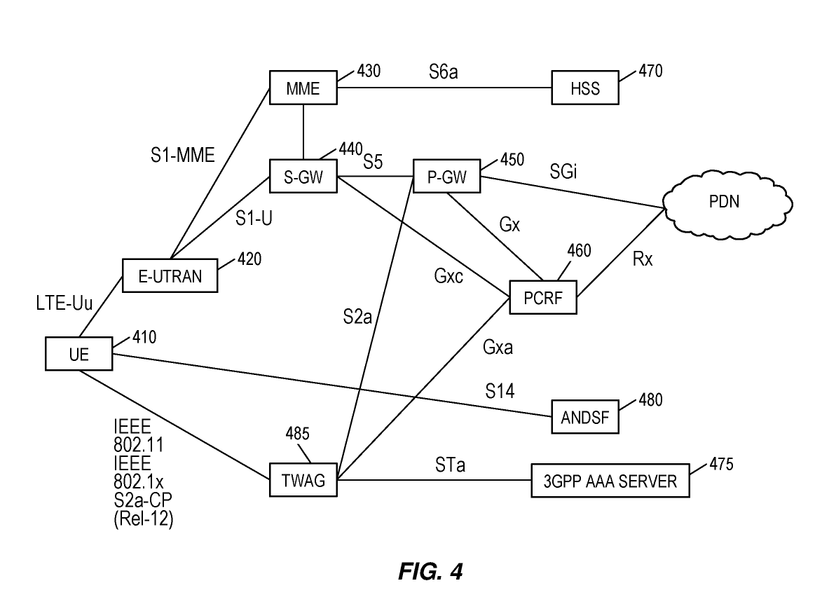

Although the techniques detailed above may be implemented in any appropriate type of wireless communication system supporting any suitable communication standards and using any suitable components, particular embodiments of the described solutions may be implemented in one or more nodes of a core network, such as in the core network of the LTE/EPC system specified by the 3GPP. Examples include one or more of the nodes illustrated in FIGS. 4 and 5. Other embodiments may be implemented in one or more nodes of a Radio Access Network (RAN), such as a node in an LTE network. These nodes include, but are not limited to, an eNodeB in an LTE network.

For example, some embodiments of a core network node configured according to the present techniques comprises means for signaling, to a network node in a first RAN, with a first RAT, a mobility indicator that indicates an allowed, disallowed, or preferred mobility of a radio bearer from the first RAN with the first RAT to a second RAN with a second RAT. Likewise, some embodiments of a network node in a first RAN, supporting a first RAT comprise means for receiving mobility signaling from a core network node, the mobility signaling comprising a mobility indicator that indicates an allowed, disallowed, or preferred mobility of at least one radio bearer from the first RAN to a second RAN with a second RAT, different from the first RAT.

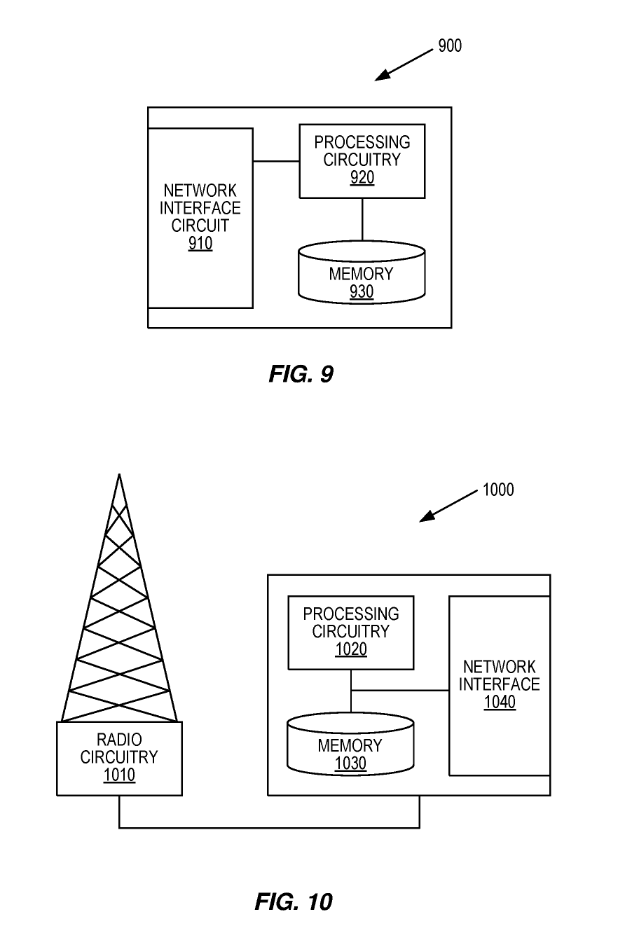

The network in which these techniques are implemented may further include any additional elements suitable to support communication between wireless devices or between a wireless device and another communication device (such as a landline telephone). Although the illustrated network nodes may represent a network communication device that includes any suitable combination of hardware and/or software, these network nodes may, in particular embodiments, represent a device such as the example core network node 900 illustrated in greater detail by FIG. 9. Similarly, although the RAN nodes (e.g., an eNB) may represent network nodes that include any suitable combination of hardware and/or software, these network nodes may, in particular embodiments, represent devices such as the example RAN node 1000 illustrated in greater detail by FIG. 10.

As shown in FIG. 9, the example core network node 900 includes processing circuitry 920, a memory 930, and network interface circuit 910. Network interface circuit 910 is adapted for communication with one or more nodes in a first radio access network, RAN, with a first radio access technology, RAT. In particular embodiments, some or all of the functionality described above as being provided by a core network node may be provided by the processing circuitry 920 executing instructions stored on a computer-readable medium, such as the memory 930 shown in FIG. 9. Thus, for example, processing circuit 920 may be adapted, e.g., with appropriate executable program instructions stored in memory 930, to signal, to a network node in the first RAN, a mobility indicator that indicates an allowed, disallowed, or preferred mobility of at least one radio bearer or for an entire context of a mobile terminal from the first RAN with the first RAT to a second RAN with a second RAT. Alternative embodiments of the network node 900 may include additional components beyond those shown in FIG. 9 and that may be responsible for providing certain aspects of the node's functionality, including any of the functionality described above and/or any functionality necessary to support the solutions described above.

As shown in FIG. 10, an example RAN node 1000 includes network interface circuit 1040, processing circuitry 1020, a memory 1030, radio circuitry 1010, and at least one antenna. In the illustrated example, RAN node 1000 is a radio node, such as an eNB or other base station. However, other RAN node embodiments that do not include radio circuitry, such as a radio network controller (RNC) or a base station controller (BSC) may be configured with similar processing circuitry, memory, and network interface circuitry. In either case, network interface circuit 1040 is adapted for communication with one or more nodes in a core network of a wireless communication system. The processing circuitry 1020 may comprise RF circuitry and baseband processing circuitry (not shown). In particular embodiments, some or all of the functionality described above as being provided by a RAN node may be provided by the processing circuitry 1020 executing instructions stored on a computer-readable medium, such as the memory 1030 shown in FIG. 10. Thus, for example, processing circuit 1020 may be adapted, e.g., with appropriate executable program instructions stored in memory 1030, to receive mobility signaling from a core network node, the mobility signaling comprising a mobility indicator that indicates an allowed, disallowed, or preferred mobility of at least one radio bearer or mobile terminal from the first RAN to a second RAN with a second RAT, different from the first RAT, and, in some embodiments, to decide to transfer one or more radio bearer connections from the first RAN to the second RAN, based on the received mobility indicator. Alternative embodiments of the network node 1000 may include additional components responsible for providing additional functionality, including any of the functionality identified above and/or any functionality necessary to support the solution described above.

In several embodiments of the present invention, a processing circuit is adapted, using suitable program code stored in memory, for example, to carry out one or more of the techniques described above, including any one of the methods discussed in connection with FIGS. 7 and 8. Of course, it will be appreciated that not all of the steps of these techniques are necessarily performed in a single microprocessor or even in a single module. It will be appreciated that a processing circuit, as adapted with program code stored in memory, can implement the process flow of FIG. 7 or FIG. 8, or variants thereof, using an arrangement of functional “modules,” where the modules are computer programs or portions of computer programs executing on the processor circuit. Accordingly, any of the apparatus described above, whether forming all or part of a core network node or a RAN node, can be understood as comprising one or more functional modules implemented with processing circuitry.

Thus, for example, a core network node apparatus may comprise a signaling module arranged to signal, to a node in a first RAN supporting a first RAT, a mobility indicator that indicates an allowed, disallowed, or preferred mobility of a radio bearer or a mobile terminal with respect to a second RAT. Likewise, a RAN node apparatus may comprise a receiving module adapted to receive mobility signaling from a core network node, the mobility signaling comprising a mobility indicator that indicates an allowed, disallowed, or preferred mobility of a radio bearer or mobile terminal from the first RAN, supporting a first RAT, to a second RAN with a second RAT, different from the first RAT. In some embodiments, the RAN node apparatus may further comprise a decision module adapted to decide whether to transfer a radio bearer connection from the first RAN to the second RAN, based on the received mobility indicator.

Advantages of various embodiments of the presently disclosed techniques include the elimination of or a reduced need for the use of UE-based ANDSF for 3GPP-WLAN integration. Another advantage is the elimination of or a reduction of the need to send new ANDSF policies when crossing borders with different direction policies.

It will be appreciated by the person of skill in the art that various modifications may be made to the above described embodiments without departing from the scope of the presently disclosed techniques. For example, it will be readily appreciated that although the above embodiments are described with reference to parts of a 3GPP network, embodiments will also be applicable to like networks, such as a successor of the 3GPP network, having like functional components. Therefore, in particular, the terms 3GPP and associated or related terms used in the above description and in the enclosed drawings and any appended claims now or in the future are to be interpreted accordingly.

Examples of several embodiments have been described in detail above, with reference to the attached illustrations of specific embodiments. Because it is not possible, of course, to describe every conceivable combination of components or techniques, those skilled in the art will appreciate that the presently disclosed techniques can be implemented in other ways than those specifically set forth herein. The present embodiments are thus to be considered in all respects as illustrative and not restrictive.

### Abbreviations

ANDSF Access network discovery and selection function
CCA Credit-Control-Answer
CCR Credit-Control-Request
UE User equipment
RAT Radio Access Technology
RRC Radio Resource Control
QoS Quality of Service
RAN Radio Access Network
ISMP Inter-System Mobility Policies
ISRP Inter-System Routing Policies
PLMN Public land mobile network
VPLMN Visited public land mobile network
LTE Long Term Evolution
EPC Evolved Packet Core
BBMPI Bearer-based mobility preference indicator
UBMPI UE-based mobility preference indicator
MSC Mobile Switching Center
GPRS General Packet Radio Service

1-25. (canceled)

26. A method in a core network node of a wireless communication system, the wireless communication system comprising a core network and a first radio access network (RAN) supporting a first radio access technology (RAT) and a second RAN supporting a second RAT, the method comprising:
signaling, to a node in the first RAN, a mobility indicator that indicates an allowed, disallowed, or preferred mobility for at least one radio bearer of a mobile terminal with respect to the second RAT, wherein the first RAT and the second RAT are the same 3GPP RAT, and wherein the second RAN consists of small cells.

27. The method of claim 26, wherein the mobility indicator indicates an allowed, disallowed, or preferred mobility of an entire context for the mobile terminal, with respect to the second RAT.

28. The method of claim 26, wherein the method further comprises detecting a trigger event, wherein said signaling is performed in response to detecting the trigger event.

29. The method of claim 28, wherein said trigger event comprises one of the following:
an addition of a radio bearer;
a modification of an existing radio bearer;
detection of a handover event or an impending handover event;
receiving of new subscription-related information for a mobile terminal;
detection of a specific application or service for a mobile terminal;
a change in dynamic Quality-of-Service control resulting in a radio bearer modification.

30. A core network node in a core network of a wireless communication system, wherein the core network node comprises means for signaling, to a network node in a first radio access network (RAN) with a first radio access technology (RAT) a mobility indicator that indicates an allowed, disallowed, or preferred mobility for at least one radio bearer of a mobile terminal from the first RAN with the first RAT to a second RAN with a second RAT, wherein the first RAT and the second RAT are the same 3GPP RAT, and wherein the second RAN consists of small cells.

31. The core network node of claim 30, wherein the mobility indicator indicates an allowed, disallowed, or preferred mobility of an entire context for the mobile terminal, with respect to the second RAT.

32. The core network node of claim 30, wherein the core network node is a network node of the Evolved Packet Core or a network node of another 3GPP core network.

33. The core network node of any claim 31, wherein the core network node further comprises means for detecting a trigger event, wherein said signaling is performed in response to detecting the trigger event.

34. The core network node of claim 33, wherein said trigger event comprises one of the following:
an addition of a radio bearer;
a modification of an existing radio bearer;
detection of a handover event or an impending handover event;
receiving of new subscription-related information for a mobile terminal;
detection of a specific application or service for a mobile terminal;
a change in dynamic Quality-of-Service control resulting in a radio bearer modification.

35. A network node in a first radio access network (RAN) supporting a first radio access technology (RAT), the network node comprising:
means for receiving mobility signaling from a core network node, the mobility signaling comprising a mobility indicator that indicates an allowed, disallowed, or preferred mobility for at least one radio bearer of a mobile terminal from the first RAN to a second RAN with a second RAT, wherein the first RAT and the second RAT are the same 3GPP RAT, and wherein the second RAN consists of small cells.

36. The network node of claim 35, wherein the mobility indicator indicates an allowed, disallowed, or preferred mobility of an entire context for the mobile terminal, with respect to the second RAT.

37. The network node of claim 35, wherein the network node further comprises means for deciding whether or not to transfer a radio bearer connection from the first RAN to the second RAN, based on the received mobility indicator of the radio bearer.

38. A core network node in a core network of a wireless communication system, the core network node comprising:
a network interface circuit configured to communicate with one or more nodes in a first radio access network (RAN) with a first radio access technology, RAT; and
a processing circuit configured to signal, to a network node in the first RAN, a mobility indicator that indicates an allowed, disallowed, or preferred mobility for at least one radio bearer of a mobile terminal from the first RAN with the first RAT to a second RAN with a second RAT, wherein the first RAT and the second RAT are the same 3GPP RAT, and wherein the second RAN consists of small cells.

39. The core network node of claim 38, wherein the mobility indicator indicates an allowed, disallowed, or preferred mobility of an entire context for the mobile terminal, with respect to the second RAT.

40. The core network node of claim 38, wherein the core network node is a network node of the Evolved Packet Core or a network node of another 3GPP core network.

41. The core network node of claim 38, wherein the processing circuit is further configured to detect a trigger event and to perform said signaling in response to detecting the trigger event.

42. The core network node of claim 41, wherein said trigger event comprises one of the following:
an addition of a radio bearer;
a modification of an existing radio bearer;
detection of a handover event or an impending handover event;
receiving of new subscription-related information for a mobile terminal;
detection of a specific application or service for a mobile terminal;
a change in dynamic Quality-of-Service control resulting in a radio bearer modification.

43. A network node in a first radio access network (RAN) supporting a first radio access technology (RAT) and comprising:
a network interface circuit configured to communicate with one or more nodes in a core network of a wireless communication system; and
a processing circuit configured to receive mobility signaling from a core network node, the mobility signaling comprising a mobility indicator that indicates an allowed, disallowed, or preferred mobility for at least one radio bearer of a mobile terminal from the first RAN to a second RAN with a second RAT, wherein the first RAT and the second RAT are the same 3GPP RAT, and wherein the second RAN consists of small cells.

44. The network node of claim 43, wherein the mobility indicator indicates an allowed, disallowed, or preferred mobility of an entire context for the mobile terminal, with respect to the second RAT.

45. The network node of claim 43, wherein the processing circuit is further configured to decide to transfer a radio bearer connection from the first RAN to the second RAN, based on the received mobility indicator of the radio bearer.

46. A method, in a network node in a first radio access network (RAN) that supports a first radio access technology (RAT), the method comprising:
receiving mobility signaling from a core network node, the mobility signaling comprising a mobility indicator that indicates an allowed, disallowed, or preferred mobility of at least one radio bearer of a mobile terminal from the first RAN to a second RAN with a second RAT, different from the first RAT; and
deciding whether or not to transfer a radio bearer connection from the first RAN to the second RAN, based on the received mobility indicator of the radio bearer, wherein the first RAT and the second RAT are the same 3GPP RAT, and wherein the second RAN consists of small cells.

47. The method of claim 46, wherein the mobility indicator indicates an allowed, disallowed, or preferred mobility of an entire context for the mobile terminal, with respect to the second RAT.
